(19) United States
(12) Patent Application Publication
(10) Pub. No.: US 2017/0155882 A1
(43) Pub. Date: Jun. 1, 2017

(54) IMAGE PROCESSING APPARATUS, IMAGE PROCESSING METHOD, IMAGING APPARATUS, AND RECORDING MEDIUM

(71) Applicant: CANON KABUSHIKI KAISHA, Tokyo (JP)

(72) Inventors: Akihiko Kanda, Kawasaki-shi (JP); Yuki Yoshimura, Tokyo (JP)

(21) Appl. No.: 15/359,872

(22) Filed: Nov. 23, 2016

(30) Foreign Application Priority Data
Dec. 1, 2015 (JP) 2015-234661

(51) Int. Cl. H04N 13/00; G06T 5/20; G06T 5/50

(52) U.S. Cl. CPC H04N 13/0025; H04N 13/0037; G06T 5/50; G06T 5/20; G06T 2207/20148; G06T 2207/10024

(57) ABSTRACT

An imaging element includes a plurality of photoelectric conversion units which photoelectrically convert an optical image of a subject imaged by an imaging optical system into an electrical signal. A first photoelectric conversion unit receives light passing through a first pupil area of the imaging optical system and a second photoelectric conversion unit receives light passing through a second pupil area of the imaging optical system. An imaging processing unit acquires a first image signal obtained from the first photoelectric conversion unit and a third image signal obtained from the first and the second photoelectric conversion units, and generates a second image signal by subtracting the first image signal from the third image signal. The image processing unit includes a limiter section to suppress the first and the second image signals from exceeding a predetermined threshold value, and performs development processing on a viewpoint image generated from the first image signal or the second image signal, or an image synthesized from the first image signal and the second image signal.

### BACKGROUND OF THE INVENTION

Field of the invention

The present invention relates to a processing technology of viewpoint images.

Description of the Related Art

There is a technique to acquire parallax images in an image processing apparatus including an imaging optical system and an imaging element. The parallax images are acquired by receiving light beams passing through each of two different pupil areas of the imaging optical system and peforming photoelectric conversion thereon by different photoelectric conversion units of the imaging element. It is possible to use the parallax image data for generation of 3D images or image synthesis. However, the acquired parallax images may have an error other than vignetting caused by an imaging optical system of an emitted light beam or image deviation due to parallax caused by various aberrations of the imaging optical system. Particularly at a time of saturation, charges of a photoelectric conversion unit are at a saturation level, and there is a possibility that crosstalk due to charge leakage occurs between adjacent photoelectric conversion units. If an error occurs in signals acquired from different pupil areas due to the crosstalk, it is not possible to acquire accurate parallax images. Therefore, Japanese Patent Laid-Open No. 2014-182360 discloses processing to suppress a signal of a photoelectric conversion unit to be equal to or less than a predetermined value.

In the technique disclosed in Japanese Patent Laid-Open No. 2014-182360, one of a pair of image signals acquiring emitted light beams of different pupil areas is set as a first image signal and the other signal is set as a second image signal. Processing to suppress the first image signal to be equal to or less than a predetermined value is performed if the first image signal is read out or an addition signal of the first image signal and the second image signal is read out from an imaging element. The second image signal is generated by subtracting the first image signal from the addition signal of the first image signal and the second image signal. Japanese Patent Laid-Open No. 2014-182360 discloses signal processing for focus detection, but does not mention how to handle a case in which parallax images are image-processed.

### SUMMARY OF THE INVENTION

In the present invention, it is possible to acquire viewpoint images on which image processing is possible even if there is a saturated pixel.

An apparatus of the present invention is an image processing apparatus which includes a storage unit configured to store a plurality of image signals acquired by performing photoelectric conversion on light passing through each of first and second pupil areas of an imaging optical system and processes data of viewpoint images generated from the plurality of image signals. The apparatus further includes, when an image signal acquired by performing photoelectric conversion on light passing through the first pupil area by a first photoelectric conversion unit is set as a first image signal, an image signal acquired by performing photoelectric conversion on light passing through the second pupil area by a second photoelectric conversion unit is set as a second image signal, and an image signal acquired by performing photoelectric conversion on light passing through the first and the second pupil areas by the first and the second photoelectric conversion units is set as a third image signal, a limiter unit configured to set a threshold value for the acquired first and second image signals and to suppress the first and the second image signals to be equal to or less than the threshold value, a generation unit configured to generate the second image signal by subtracting the first image signal from the third image signal or to generate the third image signal by adding the first image signal and the second image signal, and a development processing unit configured to perform development processing on a first viewpoint image generated from the first image signal, a second viewpoint image generated from the second image signal, or an image synthesized from the first and the second viewpoint images.

Further features of the present invention will become apparent from the following description of exemplary embodiments with reference to the attached drawings.

### BRIEF DESCRIPTION OF THE DRAWINGS

FIG. 1 is a diagram which shows a configuration example of an imaging device according to an embodiment of the present invention.

FIG. 2 is a block diagram which shows a configuration example of an image processing unit of FIG. 1.

FIG. 3 is a pixel array diagram of an imaging element of the present embodiment.

FIG. 4 is a circuit diagram of the imaging element of the embodiment.

FIG. 5 is an optical principle diagram of an imaging optical system of the embodiment.

FIGS. 6A to 6D are diagrams which describe a relationship between an amount of incident light and an output signal.

FIGS. 7A to 7D are diagrams which describe a relationship between a pixel and an output signal in the embodiment.

FIGS. 8A and 8B are diagrams which describe a relationship between an imaging element and pupil division and a relationship between an amount of defocus and an amount of image deviation.

FIG. 9 is a diagram which schematically describes refocus processing.

FIG. 10 is a diagram which schematically describes a refocus range.

FIG. 11 is a main flowchart which describes image processing of the embodiment.

FIG. 12 is a sub-flowchart of limit processing shown in S106 of FIG. 11.

FIG. 13 is a sub-flowchart which describes an image processing example of parallax images.

FIG. 14 is a flowchart which describes a control to switch whether saturation processing is necessary or not in accordance with generation of parallax images.

### DESCRIPTION OF THE EMBODIMENTS

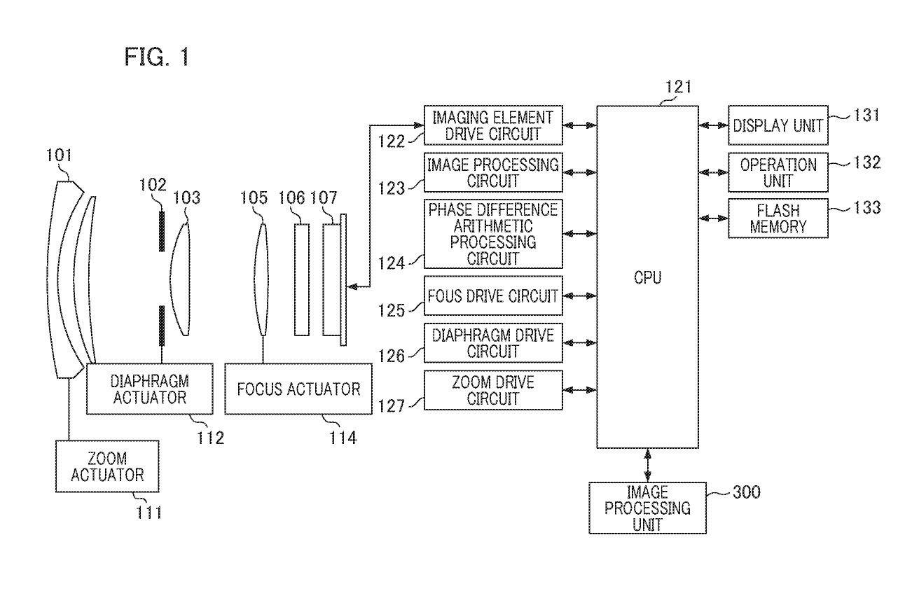

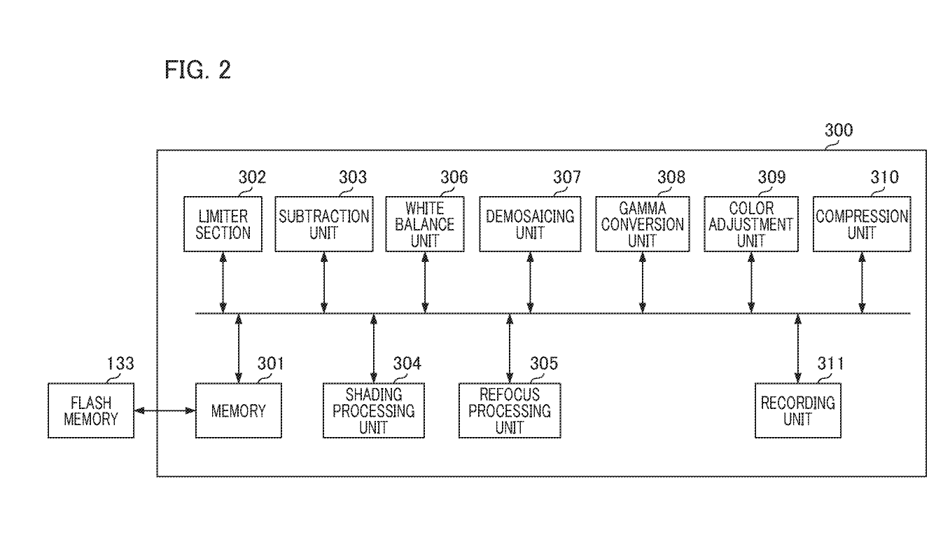

Hereinafter, embodiments of the present invention will be described in detail with reference to accompanying drawings. FIGS. 1 and 2 are configuration diagrams of an imaging device 100 and an image processing unit 300. In the present embodiment, an electronic camera in which a camera main body unit having an imaging element and an imaging optical system are integrated is described as an example. The electronic camera is capable of recording both moving images and still images. The following describes a positional relationship between respective units by defining a subject side as a front side.

In FIG. 1, a first lens group 101 placed at a front end configures an imaging optical system for imaging a subject image and is movably held in an optical axis direction. A diaphragm 102 not only performs light amount adjustment at a time of photographing by adjusting a diameter of the aperture thereof but also functions as a shutter for adjusting an exposure in seconds at a time of photographing still images. A second lens group 103 is integrated with the diaphragm 102 and driven in the optical axis direction, and has a variable magnification function (zoom function) by being interlocked with a movement operation of the first lens group 101. A third lens group 105 performs focus adjustment by moving in the optical axis direction. An optical low-pass filter 106 is an optical element for reducing a false color or moire of a photographed image.

An imaging element 107 has a pixel capable of focus detection, and is configured by, for example, a complementary metal oxide semiconductor (CMOS) image sensor and peripheral circuits thereof. In the imaging element 107, light-receiving pixels of M pixels in a horizontal direction and N pixels in a vertical direction are disposed in a square lattice form, and a two-dimensional single-plate color sensor in which a primary color mosaic filter of a Bayer array is formed of on-chips is used. The imaging element 107 has a plurality of photoelectric conversion units in each pixel and a color filter is disposed in each pixel.

A zoom actuator 111 moves the first lens group 101 and the second lens group 103 in an optical axis direction and performs a variable magnification operation by rotating a CAM cylinder (not shown). A diaphragm actuator 112 adjusts an amount of photographing light by controlling a diameter of the aperture of the diaphragm 102 and performs exposure time control at a time of photographing still images. A focus actuator 114 performs focus adjustment by moving the third lens group 105 in the optical axis direction.

A central processing unit (CPU) 121 is a control center unit responsible for each control of a camera. The CPU 121 has an operation unit, a read only memory (ROM), a random access memory (PAM), an analog (A)/digital (D) converter, a D/A converter, a communication interface circuit, and the like. The CPU 121 executes a control of various types of circuits of the camera, or a control of a series of operations such as auto-focusing (AF), photographing, image processing, recording, and the like.

An imaging element drive circuit 122 controls an imaging operation by the imaging element 107 to read out a signal from the imaging element 107. The imaging element drive circuit 122 performs A/D conversion on the acquired image signal and outputs the image signal to the CPU 121. In the following, an acquired first image is set as an A image, an acquired second image is set as a B image, and an image obtained by combining the two images is set as an A+B image. The acquired image signals are as follows:
a signal (hereinafter, referred to as an A+B image signal) obtained from a sum of outputs by two photoelectric conversion units of each pixel;
a signal obtained from one of two photoelectric conversion units of each pixel, that is, a first image signal (hereinafter, referred to as an A image signal) obtained from a first photoelectric conversion unit which receives light passing through a first pupil area of an imaging optical system; and
a second image signal (hereinafter, referred to as a B image signal) obtained from a second photoelectric conversion unit which receives light passing through a second pupil area different from the first pupil area.

There is a method of generating the A+B image signal by acquiring and adding the A image signal and the B image signal, and a method of generating the other image signal by acquiring the A+B image signal and the A image signal or the B image signal and subtracting the A image signal or the B image signal from the A+B image signal. In either method, an imaging unit outputs signals in a predetermined file format, thereby acquiring parallax (viewpoint) image data. For example, data of a first parallax (viewpoint) image are generated from the A image signal and data of a second parallax (viewpoint) image are generated from the B image signal.

An image processing circuit 123 performs correction processing (such as interpolation processing or black level correction of defective pixels) on images acquired by the imaging element 107, color interpolation, γ conversion, image compression, and the like. In the embodiment, signals which are not related to parallax images are processed by the image processing circuit 123 of the imaging device and signals (for example, the A+B image signal and the A image signal) which are related to the parallax images are processed by the image processing unit 300. In the following, first processing performed by the image processing circuit 123 and second processing performed by the image processing unit 300 are divided for convenience of description, and the second processing is mainly described. Of course, the first and the second processing may be performed by one image processing unit.

A phase difference arithmetic processing circuit 124 performs an arithmetic operation for focus detection. Specifically, an amount of image deviation between the A image and the B image is obtained by a correlation arithmetic operation and an amount of focus deviation (an amount of detected focus states) is calculated based on the A image signal and the B image signal acquired from two photoelectric conversion units of each pixel of the imaging element 107.

A focus drive circuit 125 drive-controls the focus actuator 114 based on a result of focus detection by arithmetic operations of the phase difference arithmetic processing circuit 124. The third lens group 105 performs focus adjustment by moving in the optical axis direction. The diaphragm drive circuit 126 drive-controls the diaphragm actuator 112 and controls a diameter of the aperture of the diaphragm 102. A zoom drive circuit 127 drives the zoom actuator 111 in accordance with zoom operations of a photographer. These drive circuits perform a drive-control on an optical member in charge under a control of the CPU 121.

A display unit 131 includes a display device such as a liquid crystal display (LCD). The display unit 131 displays information on a photographing mode of a camera, a preview image at a time of photographing, a confirmation image after photographing, a display image of a focus state at a time of focus detection, and the like on a screen in accordance with a control command of the CPU 121. An operation unit 132 includes a power switch, a photographing start switch, a zoom operation switch, a photographing mode selection switch, and the like, and outputs an operation instruction signal to the CPU 121. A flash memory 133 detachably attached to a camera main body unit is a device for recording photographed images including moving images and still images. Data of a plurality of parallax images (for example, the A+B image and the A image) acquired by the imaging device are output as image data in a predetermined file format. The output image data is saved in the flash memory 133.

Next, a configuration of the image processing unit 300 will be described with reference to FIG. 2.

A memory 301 saves the image data from the flash memory 133. A limiter section 302 performs limit processing to be described below on the data of a plurality of parallax images (for example, the A+B image and the A image). A subtraction unit 303 generates the B image signal by subtracting the A image signal from the A+B image signal. In FIG. 2, the subtraction unit 303 is shown as an operation unit. If the A+B image signal is generated from the A image signal and the B image signal, the operation unit is an addition unit.

A shading processing unit 304 corrects a change in an amount of light caused by image heights of the A image and the B image. Correction processing will be described in detail below. A refocus processing unit 305 generates a synthesized image by shift-adding the A image and the B image which are different parallax images in a pupil division direction. Accordingly, images at different focus positions are generated. Refocusing processing will be described in detail below.

Hereinafter, a component for performing development processing in the image processing unit 300 will be described. A white balance unit 306 executes processing to multiply a gain in each of R, G, and B colors so that the R (red) color, the G (green) color, and the B (blue) color of a white region become isochromatic. By performing white balance processing before demosaicing processing, when a chroma is calculated, it is possible to avoid having the chroma higher than a chrome, of a false color for color fog and the like, and to prevent erroneous determination. A demosaicing unit 307 interpolates color mosaic image data of two missing colors of three primary colors in each pixel, thereby generating a color image having R, G, and B color image data in all pixels. In the demosaicing processing, the interpolation processing is performed. on a focus pixel in each specified direction using surrounding pixels thereof. Then, color image data of three primary colors of R, G, and B are generated as a result of the interpolation processing in each pixel by selecting a direction.

A gamma conversion unit 308 performs gamma correction processing on color image data of each pixel and basic color image data is generated. A color adjustment unit 309 performs color adjustment processing to improve an appearance of an image. Specifically, various types of color adjustment processing such as noise reduction, chroma enhancement, hue correction, and edge enhancement are performed.

A compression unit 310 compresses color image data after the color adjustment processing in methods of the Joint Photographic Experts Group (JPEG) and the like, and reduces a data size at a time of recording. A recording unit 311 records the image data compressed by the compression unit 310 in a recording medium such as a flash memory.

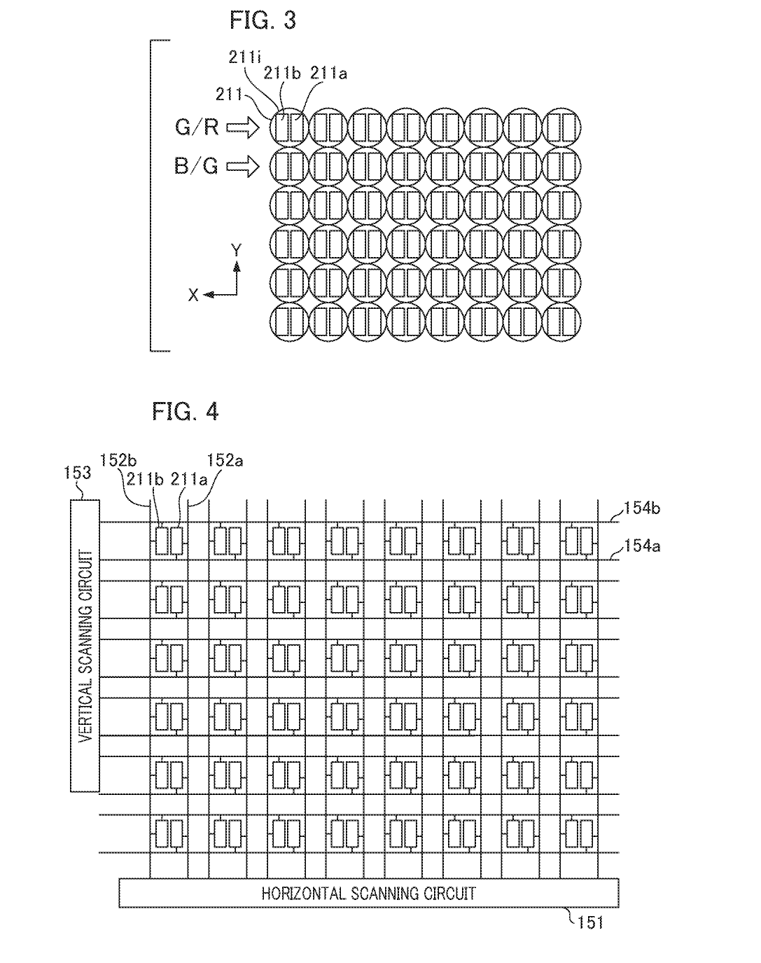

Next, a pixel array of the imaging element 107 in the embodiment will be described with reference to FIGS. 3 and 4. FIG. 3 is a diagram showing a state in which a range of six rows and eight columns of a two-dimensional CMOS area sensor is viewed from an imaging optical system side. A vertical direction is defined as a Y direction and a horizontal direction is defined as an X direction.

A color filter is in a Bayer array, and G (green) and R (red) color filters are alternately provided corresponding to a pixel sequentially from left to right in pixels of odd-numbered rows. In addition, in pixels of even-numbered rows, B (blue) and G color filters are alternately provided corresponding to a pixel sequentially from left to right. A circular frame 211i represents an on-chip microlens. A plurality of rectangles disposed inside the on-chip microlens are photoelectric conversion units, respectively. A first photoelectric conversion unit 211a receives light passing through a first pupil area which is a part of pupil areas of the imaging optical system. A second photoelectric conversion unit 211b receives light passing through a second pupil area of the imaging optical system. The embodiment describes an example in which photoelectric conversion units of all pixels are bisected in the X direction, but the number of divisions and a division direction can be arbitrarily set in accordance with specifications.

For example, with respect to bisected photoelectric conversion signals of each region, signals of the first photoelectric conversion unit 211a can be independently read for each color filter, but signals of the second photoelectric conversion unit 211b cannot be independently read. The signals of the second photoelectric conversion unit 211b are calculated by subtracting the signals of the first photoelectric conversion unit 211a from signals read out after adding outputs of the first and the second photoelectric conversion units.

Output signals of the first and the second photoelectric conversion units are used for focus detection of a phase difference method in a method to be described below. Moreover, the output signals can be also used to generate 3D (three-dimensional) images configured from a plurality of images having parallax information or refocus images synthesized by shift-adding parallax images. On the other hand, normal photographed image data is acquired from a signal obtained by adding output signals of the first and the second photoelectric conversion units.

FIG. 4 is a circuit diagram of the imaging element 107 and shows a six row and eight column range of a two-dimensional CMOS area sensor. The first photoelectric conversion unit 211a is connected to a signal line 152a of a horizontal scanning circuit 151 and a signal line 154a of a vertical scanning circuit 153, and reads out a signal. The second. photoelectric conversion unit 211b is connected to a signal line 152b of the horizontal scanning circuit 151 and a signal line 154b of the vertical scanning circuit 153, and reads out a signal.

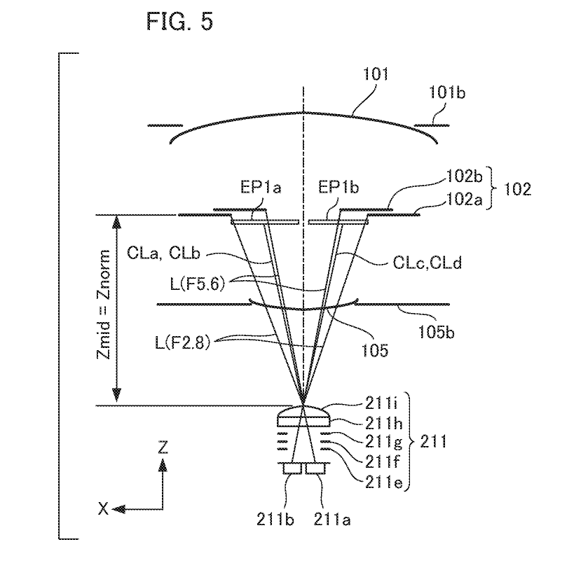

Next, an optical relationship between the imaging optical system and the imaging unit in the imaging device of the embodiment will be described with reference to Fig. 5. FIG. 5 is a diagram which describes a conjugation relationship between an exit-pupil plane of the imaging optical system and a photoelectric conversion unit of the imaging element 107 disposed at an image height of zero, that is, near a center of an image plane. An optical axis direction is defined as a Z direction in FIG. 5 and a direction orthogonal to the Z axis direction in a paper plane is defined as an X direction.

The photoelectric conversion units 211a and 211b in the imaging element 107 and the exit-pupil plane of the imaging optical system are provided to have a conjugation relationship by an on-chip lens. The exit-pupil plane of the imaging optical system substantially coincides with a plane on which an iris diaphragm for light amount adjustment is generally positioned. The imaging optical system of the embodiment is a zoom lens having a variable magnification function. If a variable magnification operation is performed depending on an optical type, a size and a distance of the exit-pupil from the image plane change. The imaging optical system of FIG. 5 shows an intermediate state, i.e., middle state, of a focal length between a wide angle end and a telephoto end. Zmid represents an exit-pupil distance in the middle state and this is assumed as a standard exit-pupil distance Znorm, and thereby a shape design of the on-chip microlens is performed.

FIG. 5 shows the first lens group 101, a barrel member 101b for holding the first lens group, and a barrel member 105b for holding the third lens group 105. The diaphragm 102 shows an aperture plate 102a which specifies a diameter of the aperture at a time of opening a diaphragm and a diaphragm blade 102b for adjusting the diameter of the aperture at a time of narrowing the diaphragm. Portions indicated by reference numerals 101b, 102a, 102b, and 105b are portions serving as a limit member for light beams passing through the imaging optical system, and shows optical virtual images when viewed from the image plane. In addition, a synthesized aperture in the vicinity of the diaphragm 102 is defined as an exit-pupil of a lens. An exit-pupil distance from the image plane is Zmid.

A pixel 211 is configured by the photoelectric conversion units 211a and 211b, wiring layers 211e to 211g, a color filter 211h, and an on-chip microlens 211i from the bottom layer. The photoelectric conversion units 211a and 211b are projected onto the exit-pupil plane of the imaging optical system by the on-chip microlens 211i. Projected images of the photoelectric conversion units 211a and 211b are shown as EP1a and EP1b, respectively. Here, if the diaphragm 102 is open (for example, F2.8), an outermost portion of the light beams passing through the imaging optical system is shown as L(F2.8). The projected images EP1a and EP1b are not subjected to vignetting at the aperture of the diaphragm. On the other hand, if the diaphragm 102 is a small diaphragm (for example, F5.6), the outermost portion of the light beams passing through the imaging optical system is shown as L (F5.6). Vignetting at the aperture of the diaphragm occurs outside the projected images EP1a and EP1b. However, a vignetting state of each of the projected images EP1a and EP1b is symmetric about the optical axis at the center of the image plane, and the amounts of light received by each of the photoelectric conversion units 211a and 211b are equal to each other.

Next, processing to generate the B image signal from the A+B image signal and the A image signal obtained from outputs of a plurality of photoelectric conversion units is described. The A+B image signal is a signal obtained from a sum of outputs of two photoelectric conversion units of each pixel of the imaging element 107, and the A image signal is a signal obtained from an output signal of one of the photoelectric conversion units. The A+B image signal and the A image signal are saved in the flash memory 133 in a predetermined file format.

The photoelectric conversion units 211a and 211b of each pixel receive light passing through the imaging optical system, respectively, and output signals corresponding to the amount of light by photoelectric conversion. However, in photographing of a subject with high brightness, a problem in which charges exceed an upper limit value of the amount of light possibly accumulated by the photoelectric conversion units 211a and 211b and leak into adjacent photoelectric conversion units, so-called crosstalk, may occur. If there is crosstalk caused by charge leakage between the A image signal generated by the photoelectric conversion unit 211a and the B image signal generated by the photoelectric conversion unit 211b, an error occurs in the A image signal and the B image signal. The error may result in generation of the B image having a low degree of coincidence with respect to the A image if the B image signal is generated by subtracting the A image signal from the A+B image signal.

If the B image signal is generated by subtracting the A image signal from the A+B image signal, the image signal has an output upper limit value. All of the A image signal, the B image signal, and the A+B image signal are assumed to have the same upper limit value. If the A image signal reaches the upper limit value, the A+B image signal also reaches the upper limit value, and thus the B image signal obtained by subtracting the A image signal from the A+B image signal becomes zero. In this case, since the A image signal equals the upper limit value and the B image signal is zero, the B image signal has a low degree of image coincidence with respect to the A image and an error is generated.

A refocus image generated by adding the A image signal and the B image signal after shift processing is performed in a pupil division direction (horizontal direction) by image processing using the parallax images (the A image and the B image) is illustrated and described. If the A image (or the B image) signal is shifted by several pixels in the horizontal direction, and the A image signal and the B image signal are added, the B image signal which is zero by saturation and the A image signal of a pixel which is not saturated are added by shift addition in a saturation boundary region. Therefore, there is a region with a low value with respect to the AH-B image signal in a case where image signals are not shift added, and a pseudo contour occurs in an image.

As described above, if each pixel is saturated at the time of photographing a subject with high brightness, the B image signal needs to be generated by setting an upper limit value for the A image signal. Then, the limiter section 302 suppresses the A image signal from exceeding a predetermined threshold value. Therefore, the B image signal can be generated after setting an upper limit value on the A image signal and can be used for image processing.

For example, a brightness signal is generated by adding outputs of a pixel having each of green (hereinafter, referred to as G1) and red R color filters of odd-numbered rows and blue B and green (hereinafter, referred to as G2) color filters of even-numbered rows with respect to the A image signal. In this case, threshold values are set for each of G1, R, B, and G2 colors, respectively. Therefore, the limiter section 302 sets the threshold values if a signal according to a specific one of G1, R, B, and G2 colors reaches an upper limit value. A threshold value is set for the A image signal and the B image signal corresponding to at least one color filter, and limit processing is performed. The set threshold value is a value less than a value of the A+B image signal which is an addition signal of the A image signal and the B image signal.

The limiter section 302 of FIG. 2 sets a threshold value for the A image signal and performs limit processing. The subtraction unit 303 generates the B image signal by subtracting the A image signal from the A+B image signal after performing limit processing.

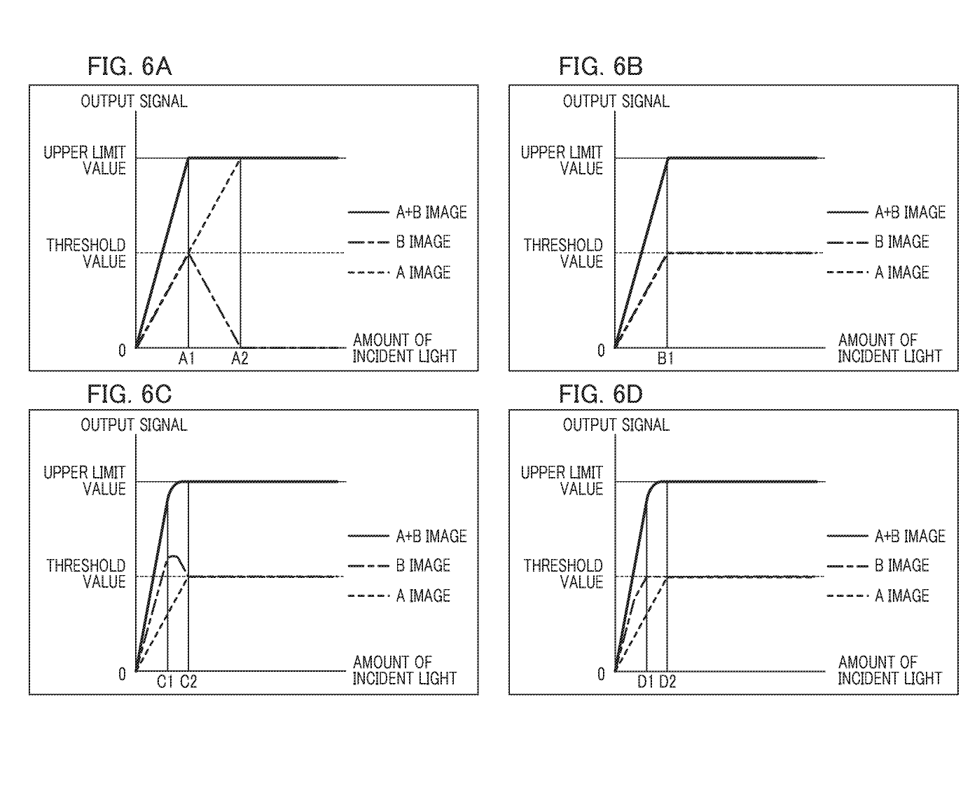

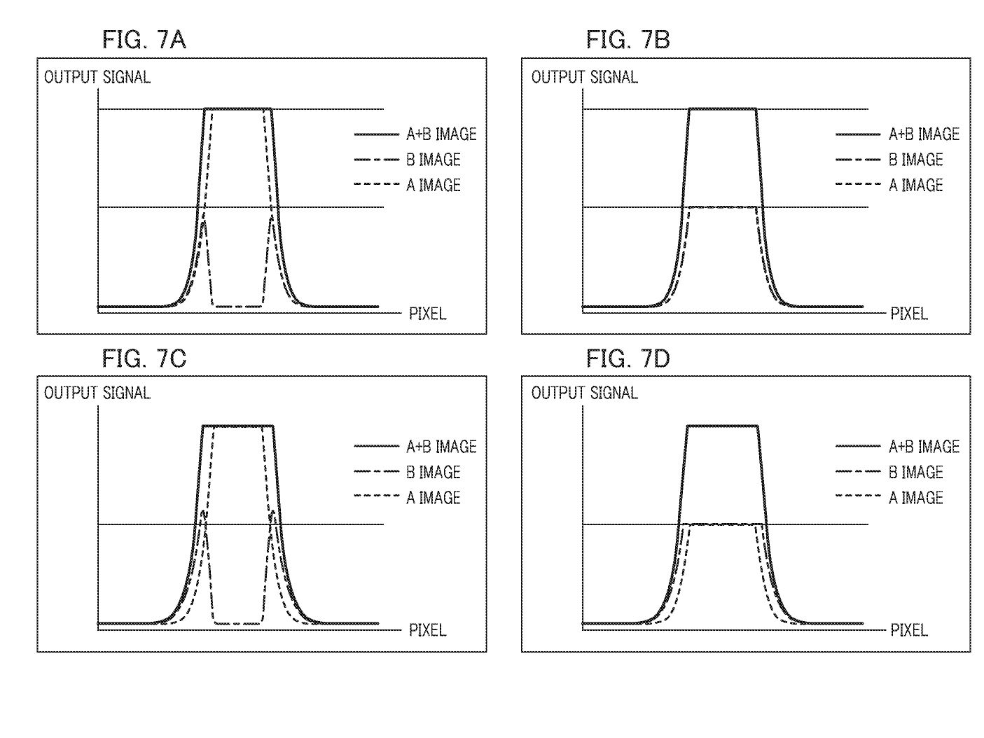

Next, a saturation processing method in a case of generating data of the A image and the B image after data of the A+B image and the A image are acquired as image file data will be described with reference to FIGS. 6 to 8. In the embodiment, the limit processing is not performed at a step of acquiring data of the A+B image and the A image as image file data, and the image processing unit 300 performs the limit processing. FIG. 6 shows a relationship between the amount of incident light from the imaging optical system and an output signal of the imaging element. A horizontal axis shows the amount of incident light and a vertical axis shows an output signal of the imaging element. FIG. 7 illustrates a real signal at a time of focusing. A horizontal axis shows a pixel (position) in an arbitrary row, and a vertical axis shows an output signal of the imaging element. In FIGS. 6 and 7, the A+B image signal is shown by a solid line in a graph, the A image signal is shown by a dotted line in the graph, and the B image signal is shown by a dot-dash line in the graph. FIGS. 6A and 7A show a case in which saturation determination is not performed, and FIGS. 6B and 7B show a case in which the saturation determination is performed.

In FIG. 6A, each pixel signal does not reach an upper limit value even if photoelectric conversion is performed on the amount of incident light in an interval from 0 to A1 of the amount of incident light. That is, the A image signal and the B image signal are signals that reflect the amount of incident light in the interval from 0 to A1. The A+B image signal exceeds the upper limit value in an interval in which the amount of incident light is A1 or more. The B image signal is generated by subtracting the A image signal from the A+B image signal, and thus the B image signal is decreased. That is, if the upper limit value of each image signal is set to the same value, when the A image signal exceeds ½ of the upper limit value, the B image signal decreases due to an effect of the A image signal. Originally, the B image signal also needs to increase with respect to an increase of the A image signal, but, when the A image signal exceeds the upper limit value, the B image signal decreases with respect to the increase of the A image signal and shows an opposite change. In this case, a degree of coincidence between the A image and the B image is significantly lowered as shown in FIG. 7A. Therefore, with respect to deviation between the A image and the B image, effects other than image deviation as parallax images are increased and image processing using the A image and the B image cannot be performed.

Next, a case in which the saturation determination is performed is described. It is assumed that the A image signal and the B image signal have the same value in FIG. 6B. The limiter section 302 sets a value which is, for example, ½ of the upper limit value of the A image signal, as a threshold value, and thus the A image signal is suppressed to the threshold value or below. Accordingly, the deviation between the A image signal and the B image signal is also suppressed to ½ of the upper limit value or below, and thus the A+B image signal does not exceed the upper limit value. As shown in FIG. 7B, since the degree of coincidence between the A image and the B image is high due to the saturation determination, the image processing using the A image and the B image can be performed.

In general, an exit pupil diameter decreases by vignetting of the imaging optical system at a periphery of a light receiving surface of the imaging element, that is, in a region with a large image height. Therefore, an amount of light received is lowered, and outputs between two photoelectric conversion units become non-uniform. As the diameter of the aperture of diaphragm decreases, non-uniformity of the amount of light received becomes significant. Accordingly, there is a possibility that the amounts of light received by two photoelectric conversion units 211a and 211b in each pixel are different from each other. In the following, saturation determination in a case where the A image signal and the B image signal acquired from output signals of the two photoelectric conversion units 211a and 211b, respectively, are not the same value will be described using FIGS. 6C and 6D, and FIGS. 7C and 7D.

FIG. 6C shows a case in which saturation determination of the A image signal is performed and saturation determination of the B image signal is not performed. FIG. 6D shows a case in which saturation determination of the A image signal and the B image signal is performed. In FIGS. 6C and 6D, the B image signal is set to be larger than the A image signal. Even in a case in which the A image signal is equal to or less than ½ of the upper limit value, there is a case in which the B image signal already exceeds ½ of the upper limit value. In this case, the A+B image signal is the upper limit value. Since the B image signal is generated by subtracting the A image signal from the A+B image signal, a false signal, as the B image signal, is output due to effects caused by the A+B image signal exceeding the upper limit value. Therefore, the degree of coincidence between the A image and the B image is significantly lowered as shown in FIG. 7C.

In the embodiment, a threshold value is also set for the B image signal as shown in FIG. 6D. That is, a threshold value for each output of the first and the second photoelectric conversion units is set, and thereby the A image signal and the B image signal are suppressed to the threshold value or below. Specifically, the threshold value is provided to set the A image signal and the B image signal to ½ of the upper limit value or below. Therefore, the B image signal cannot exceed ½ of the upper limit value. If the A image signal or the B image signal exceeds ½ of the upper limit value, a false signal due to saturation of the A+B image signal is not output as the B image signal. That is, since the degree of coincidence between the A image and the B image is high as shown in FIG. 7D, the image processing using the A image and the B image can be performed.

Next, shading correction performed by the image processing unit 300 will be described. Shading is a phenomenon in which unevenness occurs in an intensity of image signals. If a portion of light beam is blocked by the imaging optical system (including optical members such as a lens and diaphragm, or a lens barrel which holds these optical members), so-called vignetting occurs, a decrease in a signal level or shading caused by a decrease in the amount of light can occur in at least one of the A image signal and the B image signal. The decrease in an image signal level or the shading caused by vignetting causes the degree of coincidence between the A image and the B image to be lowered. The shading varies according to an exit pupil distance and a diaphragm value.

Therefore, in the embodiment, an image signal correction value for vignetting correction stored in a memory in advance is changed according to an aperture ratio, an exit pupil position, and the amount of defocus, and is applied to correction of the A image signal and the B image signal. Focus detection is performed by using the image signals after the correction. In the shading correction processing, reference correction data based on a shape of a lens, and assembling position deviation correction data obtained by measuring deviation of assembling positions of the imaging element and the lens are used. The shading is a continuously varying value depending on an image height, and thus can be expressed by an image height function. The shading varies with the image height and a combination of the diaphragm value and the exit pupil distance. For this reason, if the shading correction is performed in a lens-interchangeable camera or the like, and all correction values are stored in the memory, an enormous storage capacity is required. Therefore, as one solution, the correction values of shading are calculated under a predetermined condition (the combination of the diaphragm value and the exit pupil distance information) in the embodiment, an approximate function is obtained, and the shading correction processing is performed. In this case, since only coefficients of the approximate function need to be stored in a header portion of an image file, image data requires less storage capacity.

Specifically, processing to write correction data in the header portion of the image file is performed at a time of image output of the A+B image and the A image. The image processing unit 300 performs the shading correction processing using the correction data in the header portion at the time of image output of the A image and the B image. The shading correction processing for the A image signal and the B image signal may be performed by using other methods.

In the following, parallax images after the shading correction. processing are referred to as corrected parallax image. That is, an image obtained by performing the shading correction processing on a first parallax image is referred to as a first corrected parallax image, and an image obtained by performing the shading correction processing on a second parallax image is referred to as a second corrected parallax image. The first and the second parallax images are acquired from an output of each of the bisected photoelectric conversion units, respectively.

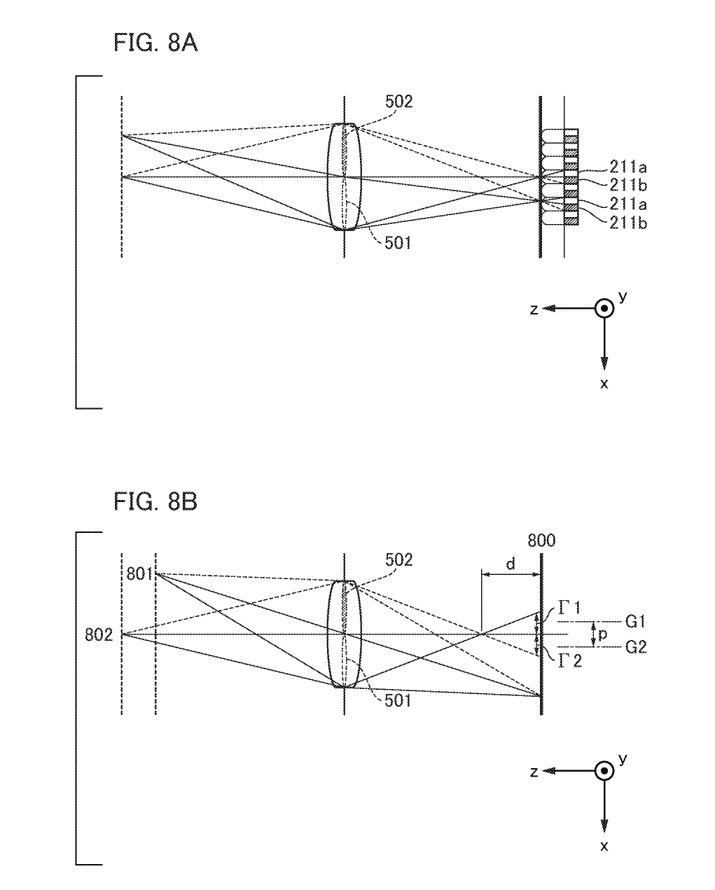

FIG. 8A is a schematic diagram which shows a correspondence relationship between the imaging element and pupil division. Light beams passing through different pupil areas, that is, a first pupil area 501 and a second pupil area 502, respectively, are incident onto each pixel of the imaging element at different angles. The incident light is received by the first photoelectric conversion unit 211a and the second photoelectric conversion unit 211b, which are bisected, respectively, and photoelectric conversion is performed thereon.

FIG. 8B is a relationship diagram which schematically shows the amount of defocus of the first parallax image and the second parallax image, and the amount of image deviation between the first parallax image and the second parallax image. The imaging element (not shown) is disposed in an imaging plane 800, and an exit pupil of the imaging optical system is bisected into the first pupil area 501 and the second pupil area 502 in the same manner as in FIG. 8A.

The amount of defocus d has a magnitude |d| representing a distance from an imaging position of a subject image to the imaging plane 800. An orientation is defined as a negative (d<0) in a front pin state in which the imaging position of a subject image is formed further toward a subject side than the imaging plane 800, and the orientation is defined as a positive (d>0) in a rear pin state which is opposite to the front pin state. D equals to 0 in a focus state in which the imaging position of a subject image is formed on the imaging plane (focus position). A position of a subject 801 shown in FIG. 8B shows a position corresponding to the focus state (d=0), and a position of a subject 802 exemplifies a position corresponding to the front pin state (d<0). In the following, the front pin state (d<0) and the rear pin state (d>0) are merged to be referred to as a de-focus state (|d|>0).

In the front pin state (d<0), among light beams from the subject 802, light beams passing through the first pupil area 501 (or the second pupil area 502) spread about a position of the center of gravity G1 (or G2) of the light beams in width Γ1 (or Γ2) after once condensed. In this case, there is a blurred image on the imaging plane 800. The blurred image is received by the first photoelectric conversion unit 211a (or the second photoelectric conversion unit 211b) which configures each of pixel portions arrayed in the imaging element, and a first parallax image signal (or a second parallax image signal) is generated. Thus, a first parallax image (or a second parallax image) is stored in a memory as image data of a subject image (blurred image) having the width Γ1 (or Γ2) at the position of the center of gravity G1 (or G2) on the imaging plane 800. The width Γ1 (or Γ2) of the subject image generally increases in proportion as the magnitude |d| of the amount of defocus d increases. In the same manner, if the amount of image deviation of the subject image between the first parallax image and the second parallax image is referred to as “p”, the magnitude |p|0 increases according to an increase in the magnitude |d| of the amount of defocus d. For example, the amount of image deviation p is defined as a difference “G1−G2” at the position of the center of gravity of the light beams, and the magnitude |p| generally increases as the |d| increases. Incidentally, an image deviation direction of the subject image between the first parallax image and the second parallax image in the rear focus state (d>0) is opposite to the front pin state, but there is a similar tendency.

Therefore, in the case of the embodiment, as the magnitude of the amount of defocus of the first parallax image and the second parallax image or an imaging signal obtained by adding the first parallax image and the second parallax image increases, the magnitude of the amount of image deviation between the first parallax image and the second parallax image increases.

Next, refocus processing will be described.

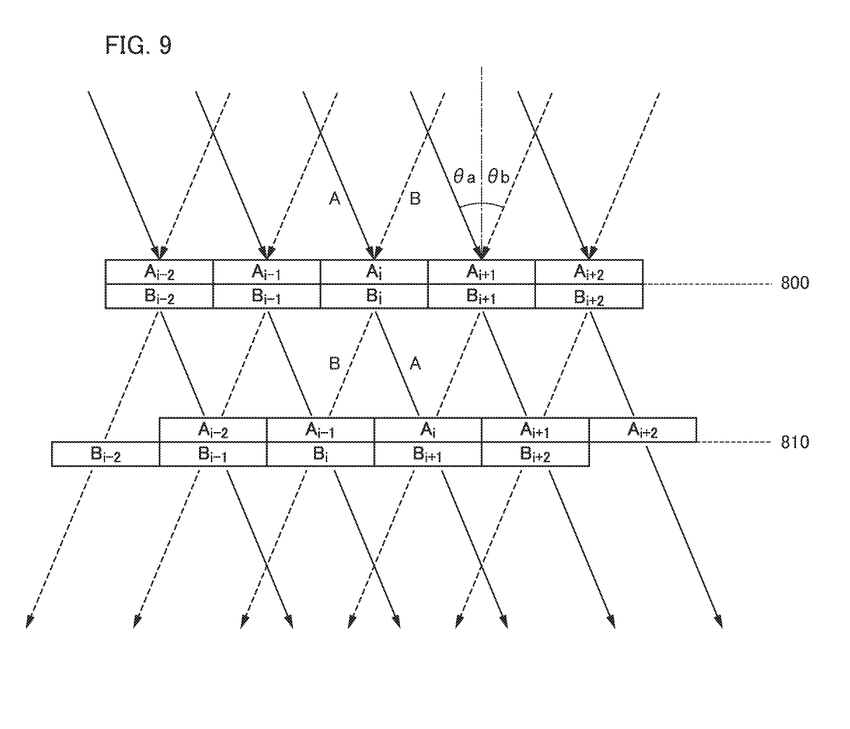

FIG. 9 is a diagram which describes refocus processing in a pupil division direction (row direction, horizontal direction) by a plurality of corrected parallax images. An imaging plane 800 of FIG. 9 corresponds to the imaging plane 800 shown in FIG. 8B. In FIG. 9, i is set as an integer variable, and a first corrected parallax image is denoted as Aᵢ and a second corrected parallax image is denoted as Bᵢ in an i^{th} pixel in a row direction of the imaging element disposed in the imaging plane 800 to provide schematic representation. A signal of the first corrected parallax image Aᵢ is a light-receiving signal of light beams incident onto the i^{th} pixel at a principle ray angle θa (corresponding to the first pupil area 501 of FIG. 8). The second corrected parallax image Bᵢ is a light-receiving signal of light beams incident onto the i^{th} pixel at a principle ray angle θb (corresponding to the second pupil area 502 of FIG. 8).

The first corrected parallax image Aᵢ and the second corrected parallax image Bᵢ have not only information on light intensity distribution but also information on incident angles. Thus, it is possible to generate a refocus signal in the virtual imaging plane 810 by performing the following parallel movement and addition processing.

(1) processing to move the first corrected parallax image Aᵢ in parallel to the virtual imaging plane 810 along the principle ray angle θa, and to move the second corrected parallax image Bᵢ in parallel to the virtual imaging plane 810 along the principle ray angle θb.

(2) processing to add the first corrected parallax image Aᵢ and the second corrected parallax image Bi, which are moved in parallel, respectively.

Moving the first corrected parallax image Aᵢ in parallel to the virtual imaging plane 810 along the principle ray angle θa corresponds to a shift of +0.5 pixel in the row direction. In addition, moving the second corrected parallax image Bᵢ parallel to the virtual imaging plane 810 along the principle ray angle θb corresponds to a shift of −0.5 pixel in the row direction. Therefore, it is possible to generate the refocus signal in the virtual imaging plane 810 by relatively shifting the first corrected parallax image Aᵢ and the second corrected parallax image Bᵢ by +1 pixel and the corrected parallax images by corresponding Aᵢ and Bᵢ₊₁ thereto. In the same manner, it is possible to generate a shift-add signal (refocus signal) in each virtual imaging plane in accordance with the amount of shift of an integer by shifting the first corrected parallax image Aᵢ and the second corrected parallax image Bᵢ by pixels of the integer and adding the corrected parallax images. In other words, using the following expression (1), the first corrected parallax image and the second corrected parallax image are shifted and added according to the amount of shift of an integer (referred to as s), and thereby a refocus image I (j, i:s) at each virtual imaging plane in accordance with the amount of shift s is generated. Here, j is a variable of an integer in a column direction.

I(j,i:s)=A(j,i)+B(j,i+s). (1)

In the embodiment, an array of the first corrected parallax image and the second corrected parallax image is a Bayer array. For this reason, the shift-addition of Expression (1) is performed for each identical color in the amount of shift s of multiples of two=2×n (n: integer). That is, the refocus image I (j, i:s) is generated, maintaining the Bayer array. Thereafter, the demosaicing processing is performed on the refocus image I (j, i:s).

When necessary, after the demosaicing processing is performed on the first and the second corrected parallax images, the refocus image may be generated by shifting and adding the first and the second corrected parallax images after the demosaicing processing. Moreover, when necessary, a refocus image in accordance with the amount of shift of a non-integer may also be generated by generating an interpolation signal between respective pixels of the first corrected parallax image and the second corrected parallax image.

A re-imaged image in accordance with a virtual imaging plane of the imaging optical system is generated from a plurality of corrected parallax images as above.

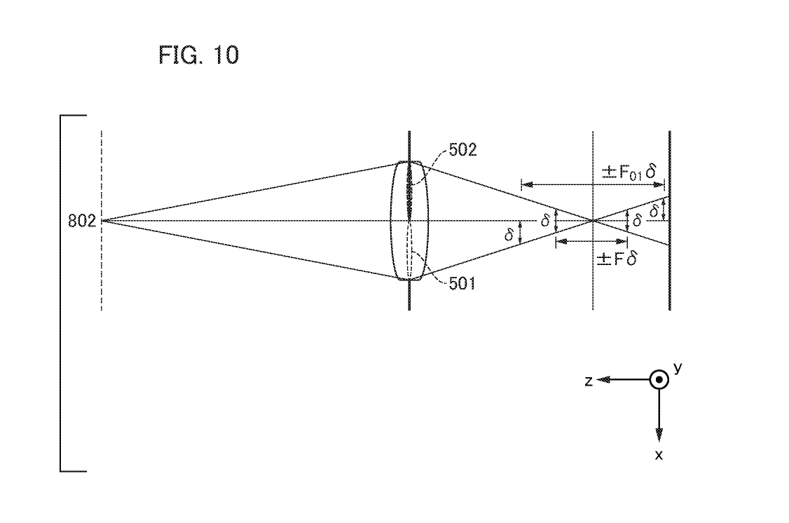

Next, a refocus range in the embodiment will be described with reference to a schematic diagram of FIG. 10. If a diameter of an allowable circle of confusion is set to δ, and a diaphragm value of the imaging optical system is set to F, a depth of focus at the diaphragm value F is ±F×δ. The number of divisions in a horizontal direction of the photoelectric conversion unit. is represented as N_{H}, the number of divisions in a vertical direction is represented as N_{V}, and a case of N_{H}=2 and N_{V}=1 is assumed. An effective diaphragm value F₀₁ (or F₀₂) of the pupil area 501 (or 502) which is bisected and narrowed has F₀₁=N_{H}×F (or F₀₂=N_{H}×F) and becomes dark. The effective depth of focus in each of first corrected parallax images (or the second corrected parallax images) is N_{H} times deeper at ±N_{H}×F×δ, a focus range is N_{H} times wider. In the range of effective depth of focus “±N_{H}×F×δ”, subject images focused in each of the first corrected parallax images (or the second corrected parallax images) are acquired. Accordingly, it is possible to refocus a focus position after photographing by shifting in parallel and adding each of the first and the second corrected parallax image along the principle ray angles θa and θb shown in FIG. 9.

The amount of defocus d from the imaging plane in which a focus position is re-adjustable after photographing is limited_{—} The refocus range of the amount. of defocus d is generally a range of following Expression (2).

|d|≦N_{H}×F×δ

The diameter of an allowable circuit of confusion is defined by δ=2·ΔX (a reciprocal number of the Nyquist frequency 1/(2·ΔX) of a pixel period ΔX) and the like.

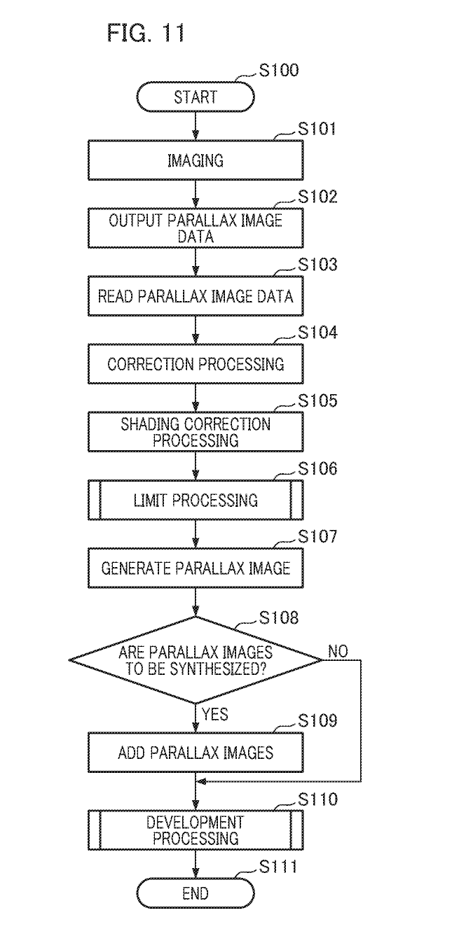

Next, with reference to the main flowchart of FIG. 11, image processing of the embodiment will be described.

After a processing start in S100, the imaging element 107 performs imaging in S101, and parallax images (the A+B image and the A image) are acquired from outputs of the imaging element 107 in S102. Parallax image data is stored in the flash memory 133 as image data in a predetermined file format. In a next step S103, the image processing unit 300 reads the image data stored in the fl ash memory 133 in S102 into the memory 301, and the procedure proceeds to S104.

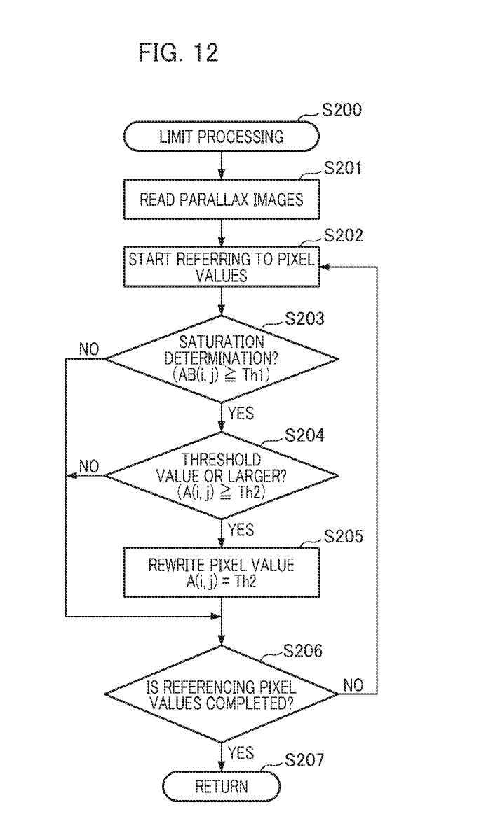

In S104, the image processing unit 300 executes correction processing on the parallax image data read-in in S103. The correction processing is pixel interpolation processing or gain adjustment. processing to correct a variation in sensitivity between pixels. Next, the image processing unit 300 executes shading correction processing in S105 and executes limit processing in S106, and the procedure proceeds to S107. The limit processing will be described below using a sub-flowchart of FIG. 12.

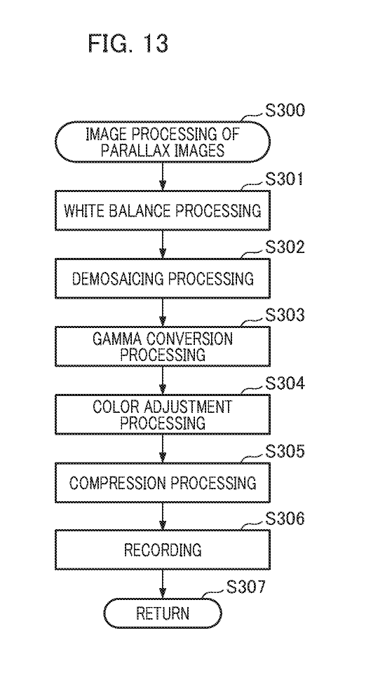

The image processing unit 300 generates parallax image data in S107. The B image signal is generated by subtracting the A image signal from the A+B image signal. The image processing unit 300 determines whether to synthesize the A image and the B image in S108. As a result of the determination, if the A image and the B image are to be synthesized, the procedure proceeds to S109, and if the A image and the B image are not to be synthesized, the procedure proceeds to S110. The image processing unit 300 performs synthesis processing by adding the A image signal and the B image signal, and the procedure proceeds to S110. The synthesis processing of parallax images includes shifting and adding to generate a refocus image, setting or changing a synthesis ratio to synthesize the A image and the B image which are parallax images, and the like. The image processing unit 300 performs various types of image processing (development processing) on the parallax image data in S110, and the procedure ends processing in S111. The development processing in S110 will be described below using a sub-flowchart of FIG. 13.

Next, with reference to FIG. 12, limit processing shown in S106 of FIG. 11 will be described. The limit processing starts in S200 and processing to read image data of the A+B image and the A image, respectively, is executed in S201. Next, in S202, the image processing unit 300 starts referencing pixel values of the images read in S201 and the procedure proceeds to S203.

The image processing unit 300 performs saturation determination processing on the A+B mage in S203. A row number is denoted as i, a column number is denoted as j, pixel values of the A+B image are denoted as AB(i, j), and a first threshold value is denoted as Th1. In the saturation determination processing of the A+B image, it is determined whether AB(i,j) is equal to or larger than the first threshold value by comparing AB (i,j) and Th1. The first threshold value Th1 is set to a maximum value of the pixel values (for example, the 14th power of two), but may be set to other values. If AB(i,j) is equal to or larger than Th1 as a result of the determination, the procedure proceeds to S204, and if AB(i,j) is smaller than Th1, the procedure proceeds to S206.

In S204, processing to compare pixel values of the A image and a second threshold value is performed. The pixel values of the A image are denoted as A(i,j) and the second threshold value is denoted as Th2, and Th2 is assumed to be smaller than Th1. It is determined whether A(i,j) is equal to or larger than the second threshold value. The second threshold value Th2 is set to a half (for example, the 13th power of two) of a maximum value of the pixel values, but may be set to other values. If A(i,j) is equal to or larger than Th2 as a result of the determination, the procedure proceeds to S205, and if A(i,j) is smaller than Th2, the procedure proceeds to S206.

The image processing unit 300 changes the pixel value A(i,j) of the A image to the second threshold value Th2 by rewriting in S205 and the procedure proceeds to S206. In S206, processing to determine whether referencing all pixel values is completed. If referencing all pixel values is completed, the procedure proceeds to S207, and if referencing all pixel values is not completed, the procedure returns to S202 to start referencing a pixel value at a position different from the current pixel position. The limit processing is completed and the procedure proceeds to a return process in S207.

Next, with reference to FIG. 13, an image processing example of parallax images will be described.

Processing starts in S300, white balance processing is performed in S301, and gains for each of R, G, B color signals are multiplied so that R, G, B colors in a white region become isochromatic. The demosaicing processing is performed in a next step S302. In the demosaicing processing, direction selection is performed after the interpolation processing in a defined direction is performed, respectively, and thereby color image signals of three primary colors of B, G, and B are generated as a result of the interpolation processing for each pixel. Gamma conversion processing is performed in S303, and the procedure proceeds to S304.

In S304, processing to improve an appearance of an image is executed by performing color adjustment processing such as noise reduction, chroma enhancement, hue correction, and edge enhancement. In a next step S305, the color-adjusted color image data is compressed in a JPEG method or the like, and the procedure proceeds to S306. In S306, processing to record the compressed image data in a recording medium is performed. The procedure ends processing in S307 to proceed to a return process, and returns to the main flowchart of FIG. 11.

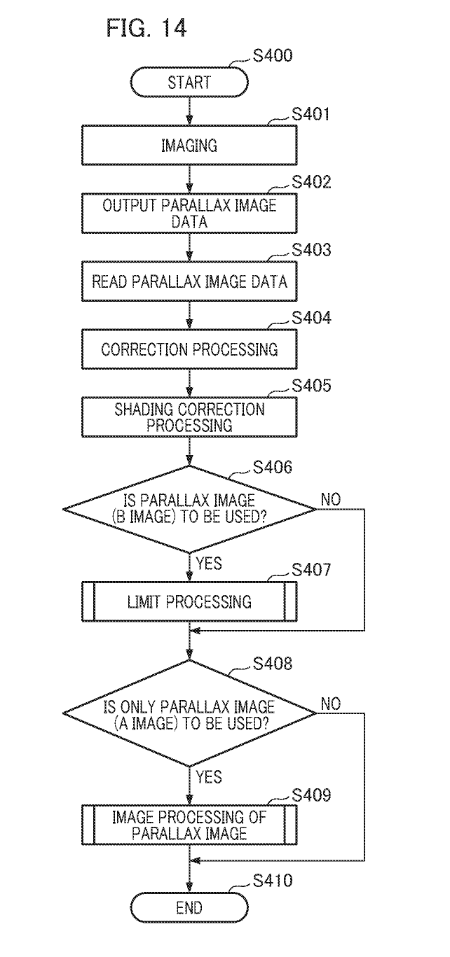

Next, with reference to FIG. 14, a case of switching whether saturation processing is necessary or not in accordance with generation of parallax images will be described. Processing starts in S400, and the procedure proceeds to S401. Processing in steps S401 to S405 are the same as in steps S101 to S105 of FIG. 11, and thus description thereof will be omitted, and description from S406 will be provided.

In S406, the CPU 121 performs processing to determine whether the B image is to be used as a parallax image. That is, it is determined whether to use the B image generated by subtracting the A image from the A+B image signal, based on the A+B image and the A image read as parallax images. For example, according to a user operation instruction, determination on whether the B image as the parallax image is to be used as an image is performed. If it is determined that the parallax image (the B image) is not to be used, the procedure proceeds to S408. If it is determined that the parallax image (the B image) is to be used, the procedure proceeds to S407.

The image processing unit 300 executes the limit processing (refer to FIG. 12) in S407, and the procedure proceeds to S408. The CPU 121 performs processing to determine whether only the parallax image (the A image) is to be used as an image in S408. If it is determined that only the parallax image (the A image) is not to be used, the procedure proceeds to S410. If it is determined that only the parallax image (the A image) is to be used, the procedure proceeds to S409. Image processing (refer to FIG. 13) on the parallax image is performed in S409, and processing ends by proceeding to S410. According to the embodiment, it is possible to generate a parallax image which can be image-processed even if there is a saturated pixel.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-234661, filed Dec. 1, 2015, which is hereby incorporated by reference wherein in its entirety.

What is claimed is:

1. An image processing apparatus which comprises a storage unit configured to store a plurality of image signals acquired by performing photoelectric conversion on light passing through each of first and second pupil areas of an imaging optical system and processes data of viewpoint images generated from the plurality of image signals, further comprising:
when an image signal acquired by performing photoelectric conversion on light passing through the first pupil area by a first photoelectric conversion unit is set as a first image signal,
an image signal acquired by performing photoelectric conversion on light passing through the second pupil area by a second photoelectric conversion unit is set as a second image signal, and
an image signal acquired by performing photoelectric conversion on light passing through the first and the second pupil areas by the first and the second photoelectric conversion unit is set as a third image signal,
a limiter unit configured to set a threshold value for the acquired first and second image signals and to suppress the first and the second image signals to be equal to or less than the threshold value;
a generation unit configured to generate the second image signal by subtracting the First image signal from the third image signal or to generate the third image signal by adding the first image signal and the second image signal; and
a development processing unit configured to perform development processing on a first viewpoint image generated from the first image signal, a second viewpoint image generated from the second image signal, or an image synthesized from the first and the second viewpoint images.

2. The image processing apparatus according to claim 1,
wherein the limiter unit is configured to set the threshold value for the first and the second image signals corresponding to different color filters and to suppress the first and the second image signals.

3. The image processing apparatus according to claim 2,
wherein the limiter unit is configured to suppress the first image signal to be equal to or less than the threshold value for at least one of a plurality of color filters.

4. The image processing apparatus according to claim 1,
wherein the threshold value is smaller than a value of the third image signal.

5. The image processing apparatus according to claim 1,
wherein the limiter unit is configured to suppress the first image signal to a second threshold value if the third image signal is equal to or more than a first threshold value and the first image signal is equal to or more than the second threshold value.

6. The image processing apparatus according to claim 1,
wherein the limiter unit does not suppress the first image signal to be equal to or less than the threshold value if the development processing unit does not perform development processing on the second viewpoint image.

7. The image processing apparatus according to claim 1, further comprising:
a correction unit configured to perform shading correction on the first and the second image signals; and
a processing unit configured to generate a signal of a refocus image synthesized by shift-adding the first and the second image signals shading corrected by the correction unit in a pupil division direction.

8. The image processing apparatus according to claim 1, further comprising:
a processing unit configured to synthesize data of the first and the second viewpoint images by a synthesis ratio.

9. An imaging apparatus which comprises an image processing apparatus and an imaging element having first and second photoelectric conversion units in each pixel,
wherein the image processing apparatus is an image processing apparatus which includes a storage unit configured to store a plurality of image signals acquired by performing photoelectric conversion on light passing each first and second pupil areas of an imaging optical system and processes data of viewpoint images generated from the plurality of image signals, and further includes
when an image signal acquired by performing photoelectric conversion on light passing through the first pupil area by a first photoelectric conversion unit is set as a first image signal,
an image signal acquired by performing photoelectric conversion on light passing through the second pupil area by a second photoelectric conversion unit is set as a second image signal, and
an image signal acquired by performing photoelectric conversion on light passing through the first and the second pupil areas by the first and the second photoelectric conversion unit is set as a third image signal,
a limiter unit configured to set a threshold value for the acquired first and second image signals and to suppress the first and the second image signals to be equal to or less than the threshold value;
a generation unit configured to generate the second image signal by subtracting the first image signal from the third image signal or to generate the third image signal by adding the first image signal and the second image signal; and
a development processing unit configured to perform development processing on a first viewpoint image generated from the first image signal, a second viewpoint image generated from the second image signal, or an image synthesized from the first and the second viewpoint images.

10. The imaging apparatus according to claim 9,
wherein the imaging element includes a plurality of micro-lenses, and
the micro-lenses correspond to the first and the second photoelectric conversion units of one pixel, respectively.

11. An image processing method executed by an image processing apparatus which includes a storage unit configured to store a plurality of image signals acquired by performing photoelectric conversion on light passing through each of first and second pupil areas of an imaging optical system and processes data of viewpoint images generated from the plurality of image signals, the method comprising:
when an image signal acquired by performing photoelectric conversion on light passing through the first pupil area by a first photoelectric conversion unit is set as a first image signal,
an image signal acquired by performing photoelectric conversion on light passing through the second pupil area by a second photoelectric conversion unit is set as a second image signal, and
an image signal acquired by performing photoelectric conversion on light passing through the first and the second pupil areas by the first and the second photoelectric conversion unit is set as a third image signal,
setting a threshold value for the acquired first and second image signals and suppressing the first and second image signals to be equal to or less than the threshold value;
generating the second image signal by subtracting the first image signal from the third image signal or generating the third image signal by adding the first image signal and the second image signal; and
performing development processing on a first viewpoint image generated from the first image signal or a second viewpoint image generated from the second image signal, or an image synthesized from the first and the second viewpoint images.

12. A non-transitory recording medium storing a control program of an image processing device causing a computer to perform each step of a control method of the image processing device, the method being executed by an image processing apparatus which includes a storage unit configured to store a plurality of image signals acquired by performing photoelectric conversion on light passing through each of first and second pupil areas of an imaging optical system and processes data of viewpoint images generated from the plurality of image signals, the method comprising:
when an image signal acquired by performing photoelectric conversion on light passing through the first pupil area by a first photoelectric conversion unit is set as a first image signal,
an image signal acquired by performing photoelectric conversion on light passing through the second pupil area by a second photoelectric conversion unit is set as a second image signal, and
an image signal acquired by performing photoelectric conversion on light passing through the first and the second pupil areas by the first and the second photoelectric conversion units is set as a third image signal,
setting a threshold value for the acquired first and second image signals and suppressing the first and second image signals to be equal to or less than the threshold value;
generating the second image signal by subtracting the first image signal from the third image signal or generating the third image signal by adding the first image signal and the second image signal; and
performing development processing on a first viewpoint image generated from the first image signal or a second viewpoint image generated from the second image signal, or an image synthesized from the first and the second viewpoint images.
